(19) United States
(12) Patent Application Publication
(10) Pub. No.: US 2024/0352320 A1
(43) Pub. Date: Oct. 24, 2024

(54) METHOD FOR PRODUCING NEEDLE COKE FROM RENEWABLE AND CIRCULAR FEEDSTOCKS

(71) Applicants: Chevron U.S.A. Inc., San Ramon, CA (US); Chevron Singapore Pte. Ltd., Singapore (SG)

(72) Inventors: Tengfei Liu, Fairfield, CA (US); Joel Edward Schmidt, Oakland, CA (US); Richard Grove, Spanish Fort, AL (US); Robert Montgomery, Moss Point, MS (US); Jon Peters, Fountain Valley, CA (US); Christopher John Ross, Brisbane (AU); Mahdi Khademi, Playa Del Rey, CA (US)

(21) Appl. No.: 18/440,287

(22) Filed: Feb. 13, 2024

Related U.S. Application Data
(60) Provisional application No. 63/460,172, filed on Apr. 18, 2023.
(60) Provisional application No. 63/521,486, filed on Jun. 16, 2023.

(51) Int. Cl. C10B 57/04; C01B 32/05; C10B 57/00; C10B 57/06; C10G 1/10; C10G 3/00

(52) U.S. Cl. CPC C10B 57/045; C01B 32/05; C10B 57/005; C10B 57/06; C10G 1/10; C10G 3/57; C10G 2300/1014; C10G 2300/4006; C10G 2300/4012

(57) ABSTRACT

A method for making needle coke includes processing a feed comprising one or more renewable feedstocks in the presence of a cracking catalyst under fluidized catalytic cracking conditions to obtain a heavy cycle oil, delayed coking the heavy cycle oil under coking conditions to obtain an intermediate coke product, and calcining the intermediate coke product under calcinating conditions to obtain needle coke.

### PRIORITY CLAIM

The present application claims priority to U.S. Provisional Patent Application Ser. No. 63/521,486, entitled “Method For Producing Needle Coke From Renewable and Circular Feedstocks,” filed Jun. 16, 2023, and to U.S. Provisional Patent Application Ser. No. 63/460,172, entitled “Method For Producing Needle Coke From Renewable Feedstock,” filed Apr. 18, 2023, the content of each of which is incorporated by reference herein in its entirety.

### BACKGROUND

Delayed coking is useful for converting vacuum residues derived from fossil fuels into various grades of coke. One such valuable coke product is needle coke. Needle coke is a highly crystalline coke that is useful in various commercial applications, such as the production of electrodes, lithium-ion batteries and ultra high-power electric arc furnaces, and demands a high price. In addition, needle coke is a highly structured carbon material obtained as a result of thermal degradation processing of petroleum derived from fluid catalytic cracking (FCC) bottoms fed to a coker, as well as being produced from coal tar. This type of carbon material has a developed fibrous structure, a low coefficient of thermal expansion, high electrical conductivity, and low contents of heteroimpurities and sulfur.

### SUMMARY

In accordance with an illustrative embodiment, a method for making needle coke, comprises:
processing a feed comprising one or more renewable feedstocks in the presence of a cracking catalyst to obtain a heavy cycle oil,
delayed coking the heavy cycle oil under coking conditions to obtain an intermediate coke product, and
calcining the intermediate coke product to obtain needle coke.

In accordance with another illustrative embodiment, a method for making renewable needle coke, comprising:
delayed coking a heavy cycle oil derived from one or more renewable sources and optionally one or more circular feedstocks under coking conditions to obtain an intermediate coke product, and
calcining the intermediate coke product to obtain renewable needle coke.

### BRIEF DESCRIPTION OF THE DRAWINGS

In combination with the accompanying drawings and with reference to the following detailed description, the features, advantages, and other aspects of the implementations of the present disclosure will become more apparent, and several implementations of the present disclosure are illustrated herein by way of example but not limitation. In the accompanying drawings:

FIG. 1 illustrates a fluid catalytic cracking (FCC) unit, according to an illustrative embodiment.

FIG. 2 illustrates a schematic diagram for the experimental setup in the example section, according to an illustrative embodiment.

### DETAILED DESCRIPTION

Various illustrative embodiments described herein are directed to methods for making needle coke from one or more renewable resources and optionally one or more circular feedstocks. As mentioned above, needle coke is produced from petroleum derived from FCC bottoms that are fed to a coker, as well as being produced from coal tar. Presently, there is an increasing interest in using renewable resources for replacing at least partly petroleum resources. However, coke products such as needle coke will be difficult to replace as they have very strict performance criteria.

The illustrative embodiments described herein overcome these and other drawbacks by providing methods for making needle coke from renewable resources resulting in a low carbon source of renewable needle coke having properties that are comparable or even improved as compared to needle coke produced from conventional petroleum resources. In non-limiting illustrative embodiments, a method for making needle coke comprises (a) processing a feed comprising one or more renewable feedstocks in the presence of a cracking catalyst under fluidized catalytic cracking conditions to obtain a heavy cycle oil, (b) delayed coking the heavy cycle oil under coking conditions to obtain an intermediate coke product, and (c) calcining the intermediate coke product to obtain needle coke.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

While compositions and methods are described in terms of “comprising” various components or steps, the compositions and methods can also “consist essentially of” or “consist of” the various components or steps, unless stated otherwise.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or +1% of the stated value.

The term “renewable” is also synonymous with the term “sustainable,” “sustainably derived,” or “from sustainable sources.”

The term “renewable feedstock” as used herein refers to a material originating from a renewable resource (e.g., plants) and non-geologically derived. The term “geologically derived” means originating from, for example, crude oil, natural gas, or coal. “Geologically derived” materials cannot be easily replenished or regrown (e.g., in contrast to plant- or algae-produced oils).

The term “circular feedstock” as used herein refers to a material at a point in time of a user or a supply chain considered as a waste/processing residue that has not been landfilled or energetically used, but instead it is reused as is, further used or recycled in a loop without being removed from the economy. In non-limiting illustrative embodiments, a circular feedstock can refer to a municipal solid waste or an industrial solid waste.

The term “municipal solid waste” as used herein refers to nonliquid waste that comes from homes, institutions, and small businesses.

The term “industrial solid waste” as used herein refers to waste that comes from the production of consumer goods which does not normally reach a consumer.

The term “recycled waste” is used herein to indicate a material recovered from both post-consumer waste and industrial waste, as opposed to virgin polymers.

The term “post-consumer waste” refers to objects having completed at least a first use cycle (or life cycle), i.e., having already served their first purpose.

The term “virgin” denotes the newly produced materials and/or objects prior to their first use, which have not already been recycled.

The term “equilibrium catalyst” or “ECAT” is used herein to indicate the inventory of circulating fluid cracking catalyst composition in an FCC unit operating under catalytic cracking conditions. For purpose of this disclosure, the terms “equilibrium catalyst,” “spent catalyst” (catalyst taken from an FCC unit) and “regenerated catalyst” (catalyst leaving a regeneration unit) shall be deemed equivalent.

A “fresh catalyst” as used herein denotes a catalyst which has not previously been used in a catalytic process.

A “spent catalyst” as used herein denotes a catalyst that has less activity at the same reaction conditions (e.g., temperature, pressure, inlet flows) than the catalyst had when it was originally exposed to the process. This can be due to a number of reasons, several non-limiting examples of causes of catalyst deactivation are coking or carbonaceous material sorption or accumulation, steam or hydrothermal deactivation, metals (and ash) sorption or accumulation, attrition, morphological changes including changes in pore sizes, cation or anion substitution, and/or chemical or compositional changes.

A “regenerated catalyst” as used herein denotes a catalyst that had become spent, as defined above, and was then subjected to a process that increased its activity to a level greater than it had as a spent catalyst. This may involve, for example, reversing transformations or removing contaminants outlined above as possible causes of reduced activity. The regenerated catalyst typically has an activity that is equal or less than the fresh catalyst activity.

The term “steady state” as used herein is used herein to indicate operating conditions within an FCC reactor unit wherein there exists within the unit a constant amount of catalyst inventory having a constant catalyst activity at a constant rate of feed of a feedstock having a defined composition to obtain a constant conversion rate of products.

The term “catalyst activity” as used herein can be determined on a weight percent basis of conversion of a standard feedstock at standard FCC conditions by the catalyst microactivity test in accordance with ASTM D3907.

The term “upgrade” or “upgrading” generally means to improve quality and/or properties of a hydrocarbon stream and is meant to include physical and/or chemical changes to a hydrocarbon stream. Further, upgrading is intended to encompass removing impurities (e.g., heteroatoms, metals, etc.) from a hydrocarbon stream, converting a portion of the hydrocarbons into shorter chain length hydrocarbons, cleaving single ring or multi-ring aromatic compounds present in a hydrocarbon stream, and/or reducing viscosity of a hydrocarbon stream.

The term “biofuel” as used herein refers here to liquid fuels obtained from renewable feedstock (e.g., feedstock of biological origin).

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

Although any processes and materials similar or equivalent to those described herein can be used in the practice or testing of the illustrative embodiments described herein, the typical processes and materials are herein described.

### Feed

The feed for processing in the presence of a cracking catalyst under fluidized catalytic cracking conditions to obtain a heavy cycle oil includes at least one or more renewable feedstocks and optionally one or more circular feedstocks.

The renewable feedstocks may originate from any renewable or biological source or sources, and is meant to include herein feedstocks other than those obtained from, for example, mineral oil, shale oil or coal.

In an illustrative embodiment, the renewable feedstocks may originate from any renewable source such as, for example, from any type of plant, animal, microorganism such as algae (e.g., algae oil, algae biomass, algae cultivation), fish and microbiological process.

Many different renewable sources derived from plants can be used. In non-limiting illustrative embodiments, plant-based renewable sources include, for example, rapeseed oil, soybean oil (including degummed soybean oil), canola oil, cottonseed oil, grape seed oil, mustard seed oil, corn oil, linseed oil, safflower oil, sunflower oil, poppy-seed oil, pecan oil, walnut oil, oat oil, peanut oil, rice bran oil, camellia oil, castor oil, and olive oil, palm oil, coconut oil, rice oil, algae oil, seaweed oil, Chinese Tallow tree oil. Other plant-based renewable sources can be obtained from, for example, argan, avocado, babassu palm, balanites, borneo tallow nut, brazil nut, calendula, camelina, caryocar, cashew nut, Chinese vegetable tallow, cocoa, coffee, cohune palm, coriander, cucurbitaceae, euphorbia, hemp, illipe, jatropha, jojoba, kenaf, kusum, macadamia nuts, mango seed, noog abyssinia, nutmeg, opium poppy, perilla, pili nut, pumpkin seed, rice bran, sacha inche, seje, sesame, shea nut, teased, allanblackia, almond, chaulmoogra, cuphea, jatropa curgas, karanja seed, neem, papaya, tonka bean, tung, and ucuuba, cajuput, clausena anisata, davana, galbanum natural oleoresin, german chamomile, hexastylis, high-geraniol monarda, juniapa-hinojo sabalero, lupine, Melissa officinalis, milfoil, ninde, patchouli, tarragon, and wormwood.

Many different renewable sources derived from animals can also be used. In non-limiting illustrative embodiments, animal-based renewable sources can include, for example, choice white grease, lard (pork fat), tallow (beef fat), fish oil, and poultry fat.

Many different renewable sources derived from microorganisms (e.g., Eukaryotes, Eubacteria and Archaca) can also be used. In non-limiting illustrative embodiments, microbe-based renewable sources include, for example, the L-glycerol lipids of Archaca and algae and diatom oils. In some embodiments, renewable sources derived from microorganisms can include bacteria, protozoa, algae, and fungi.

In some embodiments, renewable sources derived from both plant and animal sources can be used such as, for example, yellow grease, white grease, and brown grease. In non-limiting illustrative embodiments, yellow, white or brown grease can include frying oils from deep fryers and can thus include fats of both plant and animal origin. Renewable sources can specifically include used cooking oil.

In an illustrative embodiment, rrenewable feedstocks can be derived from a biological raw material component such as a vegetable oil, animal fat, and algae oil. The common feature of these sources is that they are composed of glycerides and free fatty acids (FFAs). Both of these classes of compounds contain aliphatic carbon chains having from about 8 to about 24 carbon atoms. The aliphatic carbon chains in the glycerides or FFAs can be saturated or mono-, di- or poly-unsaturated aliphatic carbon atoms.

Accordingly, in an illustrative embodiment, renewable feedstocks that can be used herein include any of those which comprise glycerides and FFAs. In one embodiment, the glycerides will contain a majority of triglycerides; however, monoglycerides and diglycerides may be present and processed as well. In an illustrative embodiment, the renewable feedstock can contain at least about 10 wt. % triglycerides. In an illustrative embodiment, the renewable feedstock can contain at least about 25 wt. % triglycerides. In an illustrative embodiment, the renewable feedstock can contain at least about 50 wt. % triglycerides. In an illustrative embodiment, the renewable feedstock can contain at least about 75 wt. % triglycerides. In an illustrative embodiment, the renewable feedstock can contain at least about 90 wt. % triglycerides. In an illustrative embodiment, the renewable feedstock can contain 100 wt. % triglycerides.

Suitable vegetable oils include, for example, castor oil, canola oil, coconut oil, corn oil, cottonseed oil, jatropha oil, linseed oil, mustard oil, olive oil, palm oil, palm kernel oil, peanut oil, rapeseed oil, safflower oil, sesame oil, soybean oil, and sunflower oil. Suitable vegetable oils can also include processed vegetable oil materials such as the fatty acids and fatty acid (C₁ to C₅) alkyl esters derived from vegetable oils.

Representative examples of animal fats include beef fat (tallow), hog fat (lard), poultry fat, and fish oil. Useful animal fats can also include processed animal fat materials such as the fatty acids and fatty acid (C₁ to C₅) alkyl esters derived from animal fats.

The renewable feedstock can also contain impurities. These impurities can include gums (e.g., phospholipids), suspended solids, and metals (e.g., Na, K, Mg, Ca, Mn, Fe, Cu, Zn).

In an illustrative embodiment, the renewable feedstocks can be subjected to at least one purification treatment prior to fluid catalytic cracking. In the purification treatment, the feedstock is fed to a purification unit, where the purification treatment is carried out. In the purification unit, at least one purification step is carried out. The purification step can be carried out by, for example, one or more of filtration, degumming, bleaching, solvent extraction, hydrolysis, ion-exchange resin treatment, mild acid wash, evaporative treatment, and any combination thereof. In addition, the purification steps may be the same or different. The purification unit comprises necessary equipment for carrying out the purification step or steps as known in the art. The purification unit may comprise one or more pieces of the same of different purification equipment, and, when more than one pieces of equipment are used, they are suitably arranged in series.

In some aspects, the renewable feedstocks predominantly comprise a renewable feedstock with no significant quantity of a hydrocarbon source or type other than the renewable feedstock. Thus, in one aspect, the renewable feedstock introduced into a riser reactor zone of an FCC unit, as discussed below, includes a material absent a hydrocarbon source other than the renewable feedstock. The feedstock introduced into the riser reactor zone can comprise less than about 10 vol. % (e.g., less than about 5 vol. %, or less than about 1 vol. %, or 0 vol. %) of a hydrocarbon source other than the renewable feedstock. By employing such a renewable feedstock, the resulting needle coke obtained from the methods of the illustrative embodiments will contain little to no fossil carbon.

In an illustrative embodiment, as may be combined with one or more of the preceding paragraphs, the renewable feedstock can be present in the feed in a major amount. In an illustrative embodiment, as may be combined with one or more of the preceding paragraphs, the renewable feedstock can be present in the feed in an amount greater than or equal to 50 wt. %, based on the total weight of the feed. In an illustrative embodiment, the renewable feedstock can be present in the feed in an amount of 100 wt. %. In an illustrative embodiment, as may be combined with one or more of the preceding paragraphs, the renewable feedstock can be present in the feed in an amount of from about 0.1 wt. % to about 50 wt. %, based on the total weight of the feed. In an illustrative embodiment, as may be combined with one or more of the preceding paragraphs, the renewable feedstock can be present in the feed in an amount of from about 0.1 wt. % to about 20 wt. %, based on the total weight of the feed.

In an illustrative embodiment, as may be combined with one or more of the preceding paragraphs, the feed can further include one or more circular feedstocks. In non-limiting illustrative embodiments, suitable one or more circular feedstocks include, for example, municipal solid waste, industrial solid waste and combinations thereof. Representative examples of municipal solid waste include, but are not limited to, domestic household waste, sewage sludge, medical or hospital waste, textiles, plastics, rubber, cartons and the like. Representative examples of industrial solid waste include, but are not limited to, industrial sludge, paper pulp sludge, waste paper, waste paperboard, textiles, plastics, rubber, cartons, and the like.

In non-limiting illustrative embodiments, suitable one or more circular feedstocks include, for example, one or more of a waste plastic feedstock, a pyrolysis-derived product of a waste plastic feedstock and combinations thereof. In illustrative embodiments, a “waste plastic” as used herein includes high density polyethylene (HDPE), low density polyethylene (LDPE), polypropylene (PP), polystyrene (PS) and mixed plastics, e.g., a mixture of polyethylene (PE), polypropylene (PP), and polystyrene (PS) or a mixture of LDPE, HDPE and PP. The waste plastic can be cofed by dissolving in other feedstocks or through a dedicated solid feeding system e.g., a screw feeder. In non-limiting illustrative embodiments, a pyrolysis-derived product of a waste plastic feedstock includes a plastic pyrolysis residue, a plastic pyrolysis oil, and combinations thereof. For example, a pyrolysis-derived product of a waste plastic can be derived by pyrolyzing waste plastic into various desirable end products such as plastic pyrolysis oil. In a non-limiting illustrative embodiment, a plastic pyrolysis oil is produced from thermal degradation of different types of waste plastics which include high density polyethene (HDPE), low density polyethene (LDPE), polypropylene (PP), polystyrene (PS), polyethylene terephthalate (PET), polyvinyl chloride (PVC) and mixed plastics, e.g., a mixture of polyethylene (PE), polypropylene (PP), and polystyrene (PS) or a mixture of LDPE, HDPE and PP. If desired, the plastic pyrolysis oil can be further refined to remove unwanted impurities such as chlorine, nitrogen, and metal contained in the plastic pyrolysis oil as known in the art.

In an illustrative embodiment, as may be combined with one or more of the preceding paragraphs, the waste plastic feedstock and the pyrolysis-derived product of a waste plastic feedstock are low carbon feedstocks. For example, in an illustrative embodiment, the waste plastic feedstock and the pyrolysis-derived product of a waste plastic feedstock are low carbon feedstocks having a zero-carbon content.

In non-limiting illustrative embodiments, suitable one or more circular feedstocks include, for example, a recycled material, which is recovered from a waste plastic material derived from post-consumer and/or post-industrial waste. In an illustrative embodiment, suitable one or more circular feedstocks include, for example, a recycled material such as recycled plastic. The plastic can be any of the plastic material described above.

In an illustrative embodiment, as may be combined with one or more of the preceding paragraphs, the circular feedstock can be present in the feed in an amount of from about 0.1 wt. % to about 50 wt. %, based on the total weight of the feed. In an illustrative embodiment, as may be combined with one or more of the preceding paragraphs, the circular feedstock can be present in the feed in an amount of from about 0.1 wt. % to about 20 wt. %, based on the total weight of the feed. In an illustrative embodiment, as may be combined with one or more of the preceding paragraphs, the circular feedstock can be present in the feed in an amount of from about 0.1 wt. % to about 10 wt. %, based on the total weight of the feed.

In an illustrative embodiment, as may be combined with one or more of the preceding paragraphs, the waste plastic feedstock can be present in the feed in an amount of from about 0.1 wt. % to about 20 wt. %, based on the total weight of the feed. In another illustrative embodiment, as may be combined with one or more of the preceding paragraphs, the waste plastic feedstock will be present in the feed in an amount of from about 0.1 wt. % to about 10 wt. %, based on the total weight of the feed.

In an illustrative embodiment, as may be combined with one or more of the preceding paragraphs, the pyrolysis-derived product of a waste plastic feedstock can be present in the feed in an amount of from about 0.1 wt. % to about 50 wt. %, based on the total weight of the feed. In another illustrative embodiment, as may be combined with one or more of the preceding paragraphs, the pyrolysis-derived product of a waste plastic feedstock can be present in the feed in an amount of from about 0.1 wt. % to about 20 wt. %, based on the total weight of the feed.

### Catalyst

The cracking catalyst for the FCC unit is circulated through the FCC unit in a continuous manner between catalytic cracking reaction and regeneration while maintaining the cracking catalyst in the reactor. In conventional processes, a catalyst injection system maintains a continuous or semi-continuous addition of fresh catalyst to the inventory circulating between the regenerator and the reactor. In the present process, discarded or spent catalyst from a high activity FCC process is employed in the place of fresh catalyst. Spent catalyst is usually considered industrial waste and some refineries pay to dispose of this material. Advantageously, such waste spent catalyst can be re-used herein for upgrading renewable feedstocks.

The spent catalyst may be added directly to a regeneration zone of the FCC unit or at any other suitable point.

In non-limiting illustrative embodiments, the cracking catalyst that can be used herein can be any known cracking catalyst for use in a fluidized catalytic cracking unit. Suitable cracking catalysts include, for example, FCC catalysts which generally comprise a zeolite. In an illustrative embodiment, a cracking catalyst can comprise either a large-pore zeolite or a mixture of at least one large-pore zeolite catalyst and at least one medium-pore molecular sieve catalyst. Suitable large-pore zeolites include, for example, a Y zeolite with or without rare earth metal, a HY zeolite with or without a rare earth metal, an ultra-stable Y zeolite with or without a rare earth metal, a Beta zeolite with or without a rare earth metal, and combination thereof. Suitable medium-pore zeolites include, for example, ZSM-5, ZSM-11, ZSM-12, ZSM-23, ZSM-35, ZSM-48, and other similar materials.

In non-limiting illustrative embodiments, a suitable cracking catalyst for use herein is an equilibrium catalyst (ECAT catalyst) such as, for example, typical ultra-stable Y based FCC catalysts such as Y based zeolite catalysts. In non-limiting illustrative embodiments, a suitable cracking catalyst for use herein is a circulating inventory of an equilibrium catalyst composition. In other non-limiting illustrative embodiments, a suitable cracking catalyst for use herein is a ZSM-5 catalyst.

In an illustrative embodiment, the cracking catalyst can comprise, on a dry basis, about 10 to about 50 wt. % by weight of a zeolite, about 5 to about 90 wt. % by weight of an amorphous inorganic oxide and 0 to about 70 wt. % by weight of a filler, based on the total weight of the catalytic cracking catalyst. Suitable amorphous inorganic oxides include, for example, silica, alumina, titania, zirconia, and magnesium oxide. Suitable fillers include, for example, clays such as kaolin and halloysite.

In an illustrative embodiment, a blend of large-pore and medium-pore zeolites may be used. For example, the weight ratio of the large-pore zeolite to the medium-pore size zeolite in the cracking catalyst can be in a range of about 100:0 to about 0:100.

The spent catalyst may be a metal poisoned spent catalyst. The metal can be an alkali metal, an alkaline earth metal, a transition metal, or a combination thereof. The alkali metal can be sodium (Na), potassium (K), or a combination thereof. The alkaline earth metal can be magnesium (Mg), calcium (Ca), or a combination thereof. The transition metal can be vanadium (V), nickel (Ni), iron (Fe), or a combination thereof. In some aspects, the metal poisoned spent catalyst comprises one or more metals selected from Na, K, Mg, Ca, V, Ni, and Fe. In other aspects, the metal doped spent catalyst comprises one or more metals selected from Na, K, Mg, and Ca. The metal poisoned spent catalyst can have a metal concentration of at least about 500 ppm (e.g., about 500 to about 35000 ppm, about 500 to about 20000 ppm, about 750 to about 20000 ppm, or about 500 to about 3000 ppm).

In an illustrative embodiment, as may be combined with one or more of the preceding paragraphs, the cracking catalyst can include at least about 80 wt. % (e.g., at least about 85 wt. %, at least about 90 wt. %, at least about 95 wt. %, or at least about 100 wt. %) of a phosphorus-containing ZSM-5 light olefins additive. Any conventional phosphorus-containing ZSM-5 light olefin additive typically used in an FCC process for light olefin production may be employed herein.

In an illustrative embodiment, the phosphorus-containing ZSM-5 light olefin additive may include, for example (a) about 25 to about 50 wt. % (e.g., about 40 to about 50 wt. %) of ZSM-5 zeolite, (b) about 3 to about 15 wt. % (e.g., about 5 to about 10 wt. %) of phosphorus, measured as P₂O₅. (c) about 5 to about 40 wt. % (e.g., about 10 to about 20 wt. %) of a clay, and (d) about 5 to about 20 wt. % (e.g., about 10 to about 20 wt. %) of a binder.

A suitable clay includes, for example, kaolin, halloysite, bentonite, and any combination thereof. In an embodiment, the clay is kaolin.

A suitable binder includes, for example, a silica sol, an alumina sol, pseudobochmite alumina, bayerite alumina, gamma-alumina, and any combination thereof.

Representative examples of suitable P/ZSM-5 light olefin additives include those commercially available from such sources as Grace (e.g., OlefinsMax®, OlefinsUltra®, OlefinsUltra® HZ, OlefinsUltra® MZ and OlefinsUltra® XZ) and from Johnson Matthey (e.g., INTERCAT™, PENTACAT™ HP, PROPYL MAX™, SUPER Z™, SUPER Z EXCEL, SUPER Z EXCEED, ISOCAT™, and OCTAMAX™).

In an embodiment, the cracking catalyst may further include, for example, a large-pore molecular sieve component in addition to the phosphorus-containing ZSM-5 light olefin additive. The large-pore molecule sieve component may include, for example, a *BEA framework type zeolite (e.g., Beta zeolite) and/or a FAU framework type zeolite (e.g., Y zeolite). When used, the large-pore molecular sieve component is typically present in an amount of no more than about 20 wt. % (e.g., about 0.1 to about 20 wt. %, or about 1 to about 15 wt. %), based on the total weight of the cracking catalyst. Optionally, the additional molecular sieve component may further comprise matrix, binder and/or clay.

The cracking catalyst may be in the form of shaped microparticles, such as microspheres. The term “microparticles” as used herein refers to particles having a size of from about 0.1 microns to about 100 microns. The size of a microparticle refers to the maximum length of a particle from one side to another, measured along the longest distance of the microparticle.

The cracking catalyst may be deactivated by contact with steam prior to use in a reactor to convert the feedstock. The purpose of steam treatment is to accelerate the hydrothermal aging which occurs in an operational FCC regenerator to obtain an equilibrium catalyst. Steam treatment may lead to the removal of aluminum from the framework leading to a decrease in the number of sites where framework hydrolysis can occur under hydrothermal and thermal conditions. This removal of aluminum results in an increased thermal and hydrothermal stability in dealuminated zeolites.

### FCC Process

It is normally preferred to carry out the catalytic cracking in a FCC unit dedicated to renewable feed cracking (i.e., with a feed comprised entirely of renewable feedstock). In such cases, the product from the cracking unit is a renewable product produced in industrially relevant amounts by the process as described herein. By “industrially relevant amounts” is meant amounts that enter the consumer market rather than laboratory scale amounts. In one example, industrially relevant amounts are produced continuously at greater than 100 liters of renewable product per day for a time period of at least one month.

In illustrative embodiments, the process may include introducing, injecting, feeding, or co-feeding the renewable feedstock and optional one or more circular feedstocks into a refinery system via a mixing zone, a nozzle, a retro-fitted port, a retro-fitted nozzle, a velocity steam line, or a live-tap. In other illustrative embodiments, the processing may comprise co-injecting the renewable feedstock and optional one or more circular feedstocks, such as co-feeding, independently or separately introducing, injecting, feeding, or co-feeding the renewable feedstock and optional one or more circular feedstocks into a fluidized catalytic cracking unit. For example, the renewable feedstock and optional one or more circular feedstocks may be provided, introduced, injected, fed, or co-fed proximate to each other into the reactor, reaction zone, reaction riser, stripper or riser quench of a fluidized catalytic cracking unit.

Fluid catalytic cracking is a conversion process in petroleum refineries wherein high-boiling, high-molecular weight hydrocarbon feedstocks are converted to more valuable gasoline, olefinic gases, and other products.

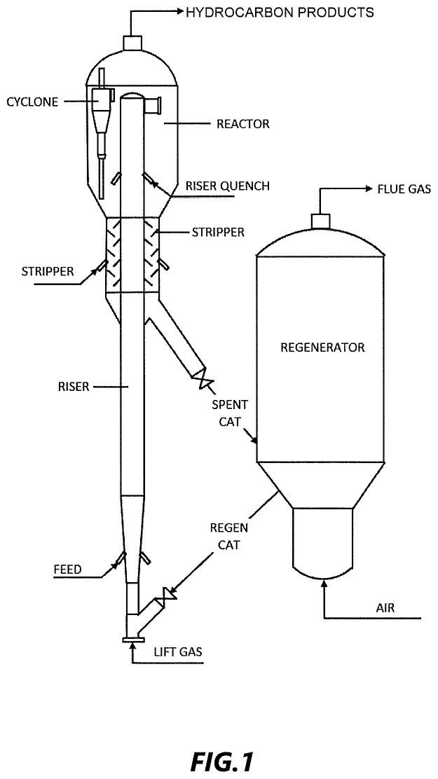

FIG. 1 depicts a schematic diagram of an illustrative fluid catalytic cracking (FCC) unit as known in the art, according to one or more illustrative embodiments. The FCC unit includes at least a riser reactor, a separator and a regenerator each thereof being operatively interconnected. It is to be understood that this configuration is merely illustrative and other configurations are contemplated herein.

In illustrative embodiments, the fluid catalytic cracking process in which the feed comprising at least one or more renewable feedstocks will be cracked to lighter hydrocarbon products takes place by contact of the feed in a cyclic catalyst recirculation cracking process with a circulating fluidizable catalytic cracking catalyst inventory as discussed above consisting of particles having a size ranging from about 20 to about 100 microns. In an illustrative embodiment, representative examples of the steps in the cyclic process include: (1) the feed is catalytically cracked in a catalytic cracking zone, normally a riser cracking zone, operating at catalytic cracking conditions by contacting the feed with a source of hot, regenerated cracking catalyst to produce an effluent comprising cracked products and spent catalyst containing coke and strippable hydrocarbons; (2) the effluent is discharged and separated, normally in one or more cyclones, into a vapor phase rich in cracked product and a solids rich phase comprising the spent catalyst; (3) the vapor phase is removed as product and fractionated in the FCC main column and its associated side columns to form liquid cracking products including gasoline; and (4) the spent catalyst is stripped, usually with steam, to remove occluded hydrocarbons from the catalyst, after which the stripped catalyst is oxidatively regenerated to produce hot, regenerated catalyst which is then recycled to the cracking zone for cracking further quantities of feed.

Suitable cracking conditions include, for example, a reaction temperature of about 425° C. to about 525° C. (e.g., about 450° C. to about 500° C.) with a catalyst regeneration temperature of about 600° C. to about 800° C.; a hydrocarbon partial pressure of about 100 to about 400 kPa (e.g., about 175 to about 250 kPa); a catalyst-to-oil ratio from about 2:1 to about 20:1 (e.g., about 3:1 to about 12:1, or about 5:1 to about 10:1); a catalyst contact time of about 1 to about 10 seconds (e.g., about 2 to about 5 seconds).

The term “hydrocarbon partial pressure” is used herein to indicate the overall hydrocarbon partial pressure in the riser reactor. The term “catalyst-to-oil ratio′ refers to the ratio of the catalyst circulation amount (e.g., ton/h) and the feedstock supply rate (e.g., ton/h). The term “catalyst contact time” is used herein to indicate the time from the point of contact between the feedstock and the catalyst at the catalyst inlet of the riser reactor until separation of the reaction products and the catalyst at the stripper outlet.

### Products

After the feed comprising the renewable feedstock and optional one or more circular feedstocks has been subjected to fluidized catalytic cracking conditions, the effluent from the reaction system having a variety of cracked hydrocarbon products may be separated into two or more constituent streams by conventional means. Constituent streams may include a fuel gas stream, an ethylene stream, a propylene stream, a butylene stream, an LPG stream, a naphtha stream, an olefin stream, a diesel stream, a gasoline stream, a heavy cycle oil (HCO) stream, a light cycle oil stream, an aviation fuel stream, a cat unit bottoms (slurry/decant oil) stream, and other hydrocarbon streams.

In some aspects, a constituent stream may be further processed. For example, an olefinic constituent stream may be sent to an alkylation unit for further processing. In addition, olefins from the constituent streams may be further separated and recovered for use in renewable plastics and petrochemicals.

Renewable hydrocarbon fuel products may be sold or further processed. Examples of further processing include blending, hydroprocessing, or alkylating at least a portion of the renewable hydrocarbon fuel product. Renewable hydrocarbon fuel products may be used as a blend stock and combined with one or more petroleum fuel products and/or renewable fuels. Petroleum-based streams include gasoline, diesel, aviation fuel, or other hydrocarbon streams obtained by refining of petroleum. Examples of renewable fuels include ethanol, propanol, and butanol.

In some aspects, the product stream can comprise a gasoline fraction in an amount ranging from about 30 wt. % to about 60 wt. % (e.g., about 40 wt. % to about 50 wt. %), based on the total product stream composition, as measured by ASTM D2887.

In an illustrative embodiment, the method includes fractionating the product stream to obtain a heavy cycle oil. The heavy cycle oil will be used in subsequent coking and calcinating steps as described below to obtain needle coke. In an illustrative embodiment, the heavy cycle oil obtained by fractionating the product stream can contain low amounts of impurities such as sulfur and nitrogen as well as higher amounts of aromatics as compared to a heavy cycle oil obtained from a product stream derived from a petroleum feedstock. In an illustrative embodiment, the heavy cycle oil can contain from about 0.01 wt. % to about 1 wt. % sulfur and about 0.01 wt. % to about 0.3 wt. % nitrogen. In another embodiment, the heavy cycle oil can contain from about 0.01 wt. % to about 0.5 wt. % sulfur and about 0.01 to about 0.1 wt. % nitrogen. In yet another illustrative embodiment, as may be combined with the other embodiments, the heavy cycle oil can contain from about 70 wt. % to about 90 wt. % of aromatics. In yet another illustrative embodiment, as may be combined with the other embodiments, the heavy cycle oil can contain from about 80 wt. % to about 95 wt. % of aromatics.

### Coking and Calcination Processes

In an illustrative embodiment, as may be combined with one or more of the preceding paragraphs, the heavy cycle oil obtained from the FCC process discussed above is subjected to coking followed by calcination to obtain needle coke. In an illustrative embodiment, the heavy cycle oil is sent to a delayed coker unit as known in the art and subjected to coking under coking conditions. In an illustrative embodiment, the coking conditions include, for example, exposing the heavy cycle oil to a temperature ranging from about 450 to about 520° C. for a time period ranging from about 12 to about 24 hours.

In an illustrative embodiment, as may be combined with one or more of the preceding paragraphs, the heavy cycle oil obtained from the FCC process discussed above can be subjected to coking in the presence of an aromatic polymer material followed by calcination to obtain needle coke. In an illustrative embodiment, the heavy cycle oil and the aromatic polymer material are sent to a delayed coker unit as known in the art and subjected to coking under coking conditions. In an illustrative embodiment, the coking conditions include, for example, exposing the heavy cycle oil and the aromatic polymer material to a temperature ranging from about 450 to about 520° C. for a time period ranging from about 12 to about 24 hours.

In an illustrative embodiment, the heavy cycle oil can be co-fed with the aromatic polymer material into the delayed coking unit. In another embodiment, a solution of the heavy cycle oil and the aromatic polymer material are fed into the delayed coking unit. For example, the solution is obtained by dissolving the aromatic polymer material in the heavy cycle oil. In an embodiment, the solution can contain from about 0.1 to about 10 wt. % of the aromatic polymer material.

In an illustrative embodiment, the aromatic polymer material includes, for example, polystyrene. Styrene is also known as ethenylbenzene, vinylbenzene, or phenylethene. The styrene-based monomer is then polymerized (facilitated by the vinyl group) to form a homo- or copolymer. For example, the styrene-based monomer is polymerized as a homopolymer to form polystyrene.

In an illustrative embodiment, as may be combined with one or more of the preceding paragraphs, the intermediate coke product obtained from the delayed coker unit is calcinated in a calciner under calcinating conditions to obtain needle coke. Suitable calcinating conditions include, for example, a temperature ranging from about 1250 to about 1400° C. and for a time period ranging from about 30 to about 60 minutes.

In an illustrative embodiment, the needle coke thus obtained has a renewable carbon content up to 100%.

The following examples are intended to be non-limiting.

### Examples 1-8 and Comparative Example 1

A series of laboratory tests were carried out to study renewable sources cracking under FCC conditions. The renewable sources used were algae, canola oil, soybean oil, used cooking oil, corn oil, and tallow. The catalyst was regenerated equilibrium catalyst (Ecat) obtained from an FCC unit or a ZSM-5 catalyst.

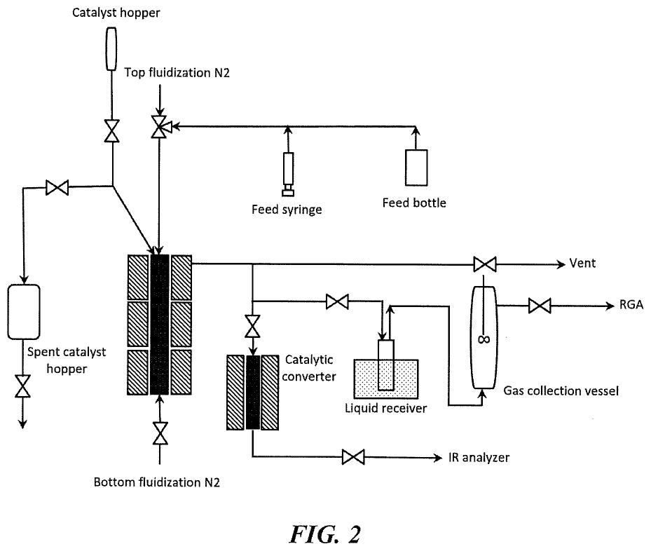

Catalytic cracking experiments were carried out using an Advanced Cracking Evaluation (ACE) Model C unit fabricated by Kayser Technology. A schematic diagram of the ACE Model C unit is shown in FIG. 2. The reactor employed in the ACE unit was a fixed fluidized reactor with 1.6 cm ID. Nitrogen was used as fluidization gas and introduced from both bottom and top. The top fluidization gas was used to carry the feed injected from a calibrated syringe feed pump via a three-way valve. The catalytic cracking of the feed was carried out at atmospheric pressure and 975° F. For each experiment, a constant amount of feed was injected at the rate of 1.2 g/min for 75 seconds. The catalyst-to-oil mass ratio was maintained at 6 for each catalyst tested. After 75 seconds of feed injection, the catalyst was stripped off by nitrogen for a period of 525 seconds.

During the catalytic cracking and stripping process, the liquid product was collected in a sample vial attached to a glass receiver, which was located at the end of the reactor exit and was maintained at −15° C. The gaseous products were collected in a closed stainless-steel vessel (12.6 L) prefilled with N₂ at 1 atm. Gaseous products were mixed by an electrical agitator rotating at 60 rpm as soon as feed injection was completed. After stripping, the gaseous products were further mixed for 10 mins to ensure homogeneity. The final gaseous products were then analyzed using a refinery gas analyzer (RGA).

After the completion of the stripping process, in-situ catalyst regeneration was carried out in the presence of air at 1300° F. The regeneration flue gas is passed through a catalytic converter packed with CuO pellets (LECO Inc.) to oxidize CO to CO₂. The regeneration flue gas was then analyzed by an online infrared (IR) analyzer located downstream from the catalytic converter. Coke deposited during the cracking process was calculated from the CO₂ concentrations measured by the IR analyzer.

As mentioned above, gaseous products, mainly C₁ to C₇ hydrocarbons, were resolved in the RGA. The RGA is a customized Agilent 7890B gas chromatograph (GC) equipped with three detectors, a flame ionization detector for hydrocarbons and two thermal conductivity detectors for nitrogen and hydrogen. A methanizer was also installed on the RGA to quantify trace amount of CO and CO₂ in the gas products. Gas products were grouped into dry gas (C₂-hydrocarbons and H₂) and liquefied petroleum gas (C₃ and C₄ hydrocarbons). CO and CO₂ were excluded from the dry gas. Liquid products were weighed and analyzed in a simulated distillation GC (Agilent 6890) using ASTM D2887. The liquid products were cut into gasoline (C₅ to 430° F.), light cycle oil (430° F.+ to 650° F.) and heavy cycle oil (650° F.+). Gasoline (C₅₊ hydrocarbons) in the gaseous products were combined with gasoline in the liquid products as total gasoline. Light ends in the liquid products (C₅₋) were also subtracted from liquid products and added back to C₃ and C₄ species using some empirical distributions. Material balances were between 98% and 101% for most experiments.

Detailed hydrocarbon analysis (DHA) using Agilent 6890A (Separation Systems Inc.) were also performed on the gasoline portion of liquid products for PONA (paraffins, olefins, naphthenes, and aromatics) and octanes (RON and MON). DHA analysis on the gasoline portion in gaseous products was not performed. Therefore, the adjustment to total gasoline properties was not performed. Nevertheless, the DHA results still provided information for evaluating catalytic cracking product properties as set forth below in Table 1.

TABLE 1

| | Comp. Ex./Ex. | | | | | | | | |
|---|---|---|---|---|---|---|---|---|---|
| | Comp. | | | | | | | | |
| | Ex. 1 | Ex. 1 | Ex. 2 | Ex. 3 | Ex. 4 | Ex. 5 | Ex. 6 | Ex. 7 | Ex. 8 |
| Feedstock | VGO | Algae | Canola | Soybean | Used | Corn | Tallow | Palm | Soybean |
| | | | | oil | cooking | oil | | oil | oil |
| | | | | | oil | | | | |
| Catalyst | Ecat | Ecat | Ecat | Ecat | Ecat | Ecat | Ecat | Ecat | ZSM-5 |
| Conversion, wt % | 76.82 | 84.08 | 82.27 | 81.36 | 82.49 | 82.30 | 85.76 | 85.64 | 92.77 |
| Cat/Oil, wt/wt | 6 | 6 | 6 | 6 | 6 | 6 | 6 | 6 | 6 |
| Yields, wt. % | | | | | | | | | |
| Coke | 3.90 | 5.78 | 5.31 | 5.46 | 5.40 | 5.46 | 5.49 | 6.31 | 1.20 |
| Dry Gas | 2.09 | 2.30 | 2.29 | 2.31 | 2.32 | 2.48 | 2.12 | 2.14 | 6.05 |
| LPG | 18.56 | 17.72 | 16.18 | 15.73 | 16.36 | 16.00 | 19.06 | 19.19 | 27.38 |
| Standard cut | 52.18 | 45.66 | 46.05 | 45.36 | 45.80 | 45.70 | 45.89 | 45.68 | 44.85 |
| gasoline | | | | | | | | | |
| (C5-430° F.) | | | | | | | | | |
| LCO | 15.46 | 12.26 | 13.77 | 14.53 | 13.73 | 13.98 | 11.09 | 11.08 | 4.34 |
| (430° F.-650° F.) | | | | | | | | | |
| HCO (650° F.+) | 7.72 | 3.66 | 3.96 | 4.11 | 3.78 | 3.72 | 3.15 | 3.29 | 2.89 |
| CO | 0.01 | 1.34 | 1.48 | 1.42 | 1.61 | 1.37 | 1.84 | 1.39 | 4.07 |
| CO2 | 0.07 | 0.82 | 0.88 | 0.84 | 0.95 | 0.75 | 1.22 | 0.88 | 0.52 |
| H2O | 0.00 | 10.45 | 10.07 | 10.25 | 10.05 | 10.55 | 10.14 | 10.04 | 8.69 |
| Gasoline properties | | | | | | | | | |
| RON-GC | 96.08 | 96.49 | 99.17 | 99.40 | 98.60 | 99.87 | 95.57 | 97.09 | 120.24 |
| MON-GC | 81.78 | 80.43 | 80.24 | 80.92 | 80.13 | 81.34 | 75.84 | 84.52 | 86.98 |
| (R + M)/2 | 88.93 | 88.46 | 89.70 | 90.16 | 89.37 | 90.61 | 85.71 | 90.81 | 103.61 |
| Gasoline | 2.77 | 2.65 | 3.12 | 2.76 | 3.09 | 2.72 | 3.79 | 3.83 | 0.97 |
| nParaffins, wt. % | | | | | | | | | |
| Gasoline Iso- | 22.66 | 17.75 | 16.71 | 16.15 | 16.96 | 15.97 | 21.02 | 13.63 | 5.23 |
| paraffins, wt. % | | | | | | | | | |
| Gasoline | 57.24 | 61.58 | 62.59 | 63.27 | 61.48 | 63.17 | 55.03 | 62.63 | 86.73 |
| aromatics, wt. % | | | | | | | | | |
| Gasoline | 7.75 | 7.59 | 6.40 | 6.55 | 6.23 | 6.59 | 5.78 | 3.85 | 1.20 |
| naphthenes, wt. % | | | | | | | | | |
| Gasoline | 8.70 | 10.91 | 10.70 | 10.54 | 11.47 | 10.82 | 13.08 | 16.03 | 5.26 |
| olefins, wt. % | | | | | | | | | |

The results from Ex. 1 to Ex. 7 show that cracking biofeedstocks using the same catalyst such as ECAT, the amount of gasoline aromatics is comparable to the amount of gasoline aromatics derived from cracking petroleum feedstocks such as vacuum gas oil (VGO). In particular, except for cracking tallow, the cracking of all other biofeedstocks increased the gasoline aromatics and hence octane numbers. While not directly measured, it is believed that HCO aromatics from cracking biofeedstocks (except tallow) should also be higher than cracking VGO.

Ex. 8 shows that when using ZSM-5 as a catalyst, the gasoline aromatics are even higher than when using ECAT as a catalyst (Ex. 3). Therefore, using ZSM-5 can further increase the aromaticity of products such as gasoline and HCO.

Biofeedstocks contain less sulfur and nitrogen than typical vacuum gas oil. As a result, the HCO from cracking biofeedstocks also contain less sulfur and nitrogen, which makes them better quality feeds for needle coke.

According to an aspect of the present disclosure, a method for making needle coke comprises:
(a) processing a feed comprising one or more renewable feedstocks in the presence of a cracking catalyst under fluidized catalytic cracking conditions to obtain a heavy cycle oil,
(b) delayed coking the heavy cycle oil under coking conditions to obtain an intermediate coke product, and
(c) calcining the intermediate coke product under calcinating conditions to obtain needle coke.

In one or more additional illustrative embodiments, as may be combined with the preceding paragraphs, the one or more renewable feedstocks comprise one or more of a plant, animal and microorganism type renewable feedstock.

In one or more additional illustrative embodiments, as may be combined with the preceding paragraphs, the one or more renewable feedstocks comprise a material selected from the group consisting of monoglycerides, diglycerides, triglycerides, fatty acids and mixtures thereof.

In one or more additional illustrative embodiments, as may be combined with the preceding paragraphs, the one or more renewable feedstocks comprise at least about 10 wt. % triglycerides.

In one or more additional illustrative embodiments, as may be combined with the preceding paragraphs, the one or more renewable feedstocks comprise at least about 50 wt. % triglycerides.

In one or more additional illustrative embodiments, as may be combined with the preceding paragraphs, the one or more renewable feedstocks comprise at least about 75 wt. % triglycerides.

In one or more additional illustrative embodiments, as may be combined with the preceding paragraphs, the feed comprises from about 0.1 to about 50 wt. % of the one or more renewable feedstocks, based on the total weight of the feed.

In one or more additional illustrative embodiments, as may be combined with the preceding paragraphs, the feed comprises from greater than or equal to about 50 wt. % of the one or more renewable feedstocks, based on the total weight of the feed.

In one or more additional illustrative embodiments, as may be combined with the preceding paragraphs, the feed comprises 100 wt. % of the one or more renewable feedstocks.

In one or more additional illustrative embodiments, as may be combined with the preceding paragraphs, the feed further comprises one or more circular feedstocks.

In one or more additional illustrative embodiments, as may be combined with the preceding paragraphs, the circular feedstock is present in the feed in an amount of from about 0.1 wt. % to about 50 wt. %, based on the total weight of the feed.

In one or more additional illustrative embodiments, as may be combined with the preceding paragraphs, the feed further comprises one or more of a waste plastic feedstock, a pyrolysis-derived product of a waste plastic feedstock and combinations thereof.

In one or more additional illustrative embodiments, as may be combined with the preceding paragraphs, the feed comprises the waste plastic feedstock, and the waste plastic feedstock is present in the feed in an amount of from about 0.1 wt. % to about 20 wt. %, based on the total weight of the feed.

In one or more additional illustrative embodiments, as may be combined with the preceding paragraphs, the feed comprises the pyrolysis-derived product of a waste plastic feedstock, and the pyrolysis-derived product of a waste plastic feedstock is present in the feed in an amount of from about 0.1 to about 20 wt. % of the pyrolysis-derived product of the waste plastic feedstock, based on the total weight of the feed.

In one or more additional illustrative embodiments, as may be combined with the preceding paragraphs, the feed comprises from about 0.1 to about 10 wt. % of the waste plastic feedstock, based on the total weight of the feed, and from about 0.1 to about 20 wt. % of the pyrolysis-derived product of the waste plastic feedstock, based on the total weight of the feed.

In one or more additional illustrative embodiments, as may be combined with the preceding paragraphs, the cracking catalyst comprises an equilibrium catalyst.

In one or more additional illustrative embodiments, as may be combined with the preceding paragraphs, the cracking catalyst comprises a ZSM-5 catalyst.

In one or more additional illustrative embodiments, as may be combined with the preceding paragraphs, the fluidized catalytic cracking conditions comprise a temperature of 425° C. to about 525° C., a catalyst regeneration temperature of about 600° C. to about 800° C.; a hydrocarbon partial pressure of about 100 to about 400 kPa, a catalyst-to-oil ratio from about 2:1 to about 20:1; and a catalyst contact time of about 1 to about 10 seconds.

In one or more additional illustrative embodiments, as may be combined with the preceding paragraphs, the heavy cycle oil comprises about 75 to about 99 wt. % of aromatics.

In one or more additional illustrative embodiments, as may be combined with the preceding paragraphs, the heavy cycle oil further comprises about 0.1 to about 0.5 wt. % sulfur and about 0.1 to about 0.5 wt. % nitrogen.

In one or more additional illustrative embodiments, as may be combined with the preceding paragraphs, the coking conditions comprise a temperature ranging from about 450 to about 520° C. for a time period ranging from about 12 to about 24 hours, and wherein the calcinating conditions comprise a temperature ranging from about 1250 to about 1400° C. for a time period ranging from about 30 to about 60 minutes.

In one or more additional illustrative embodiments, as may be combined with the preceding paragraphs, where delayed coking the heavy cycle oil comprises delayed coking the heavy cycle oil in the presence of an aromatic polymer material under coking conditions to obtain the intermediate coke product.

In one or more additional illustrative embodiments, as may be combined with the preceding paragraphs, wherein delayed coking the heavy cycle oil in the presence of the aromatic polymer material comprises cofeeding the heavy cycle oil and the aromatic polymer material into a delayed coker unit and delayed coking the co-fed heavy cycle oil and aromatic polymer material.

In one or more additional illustrative embodiments, as may be combined with the preceding paragraphs, where delayed coking the heavy cycle oil in the presence of the aromatic polymer material comprises delayed coking a solution of the heavy cycle oil and the aromatic polymer material in a delayed coker unit.

In one or more additional illustrative embodiments, as may be combined with the preceding paragraphs, the solution comprises from about 0.1 to about 10 wt. % of the aromatic polymer material, based on the total weight of the solution.

In one or more additional illustrative embodiments, as may be combined with the preceding paragraphs, the aromatic polymer material is polystyrene.

According to another aspect of the invention, a method for making renewable needle coke comprises:
(a) delayed coking a heavy cycle oil derived from one or more renewable sources and optionally one or more circular feedstocks under coking conditions to obtain an intermediate coke product, and
(b) calcining the intermediate coke product to obtain renewable needle coke.

In one or more additional illustrative embodiments, as may be combined with the preceding paragraphs, where delayed coking the heavy cycle oil comprises delayed coking the heavy cycle oil in the presence of an aromatic polymer material under coking conditions to obtain the intermediate coke product.

In one or more additional illustrative embodiments, as may be combined with the preceding paragraphs, wherein delayed coking the heavy cycle oil in the presence of the aromatic polymer material comprises cofeeding the heavy cycle oil and the aromatic polymer material into a delayed coker unit and delayed coking the co-fed heavy cycle oil and aromatic polymer material.

In one or more additional illustrative embodiments, as may be combined with the preceding paragraphs, where delayed coking the heavy cycle oil in the presence of the aromatic polymer material comprises delayed coking a solution of the heavy cycle oil and the aromatic polymer material in a delayed coker unit.

In one or more additional illustrative embodiments, as may be combined with the preceding paragraphs, the solution comprises from about 0.1 to about 10 wt. % of the aromatic polymer material, based on the total weight of the solution.

In one or more additional illustrative embodiments, as may be combined with the preceding paragraphs, the coking conditions comprise a temperature ranging from about 450 to about 520° C. for a time period ranging from about 12 to about 24 hours, and wherein the calcinating conditions comprise a temperature ranging from about 1250 to about 1400° C. for a time period ranging from about 30 to about 60 minutes.

In one or more additional illustrative embodiments, as may be combined with the preceding paragraphs, the one or more renewable feedstocks comprise one or more of a plant, animal and microorganism type renewable feedstock.

In one or more additional illustrative embodiments, as may be combined with the preceding paragraphs, the one or more renewable feedstocks comprise a material selected from the group consisting of monoglycerides, diglycerides, triglycerides, fatty acids and mixtures thereof.

In one or more additional illustrative embodiments, as may be combined with the preceding paragraphs, the one or more renewable feedstocks comprise at least about 10 wt. % triglycerides.

In one or more additional illustrative embodiments, as may be combined with the preceding paragraphs, the one or more renewable feedstocks comprise at least about 50 wt. % triglycerides.

In one or more additional illustrative embodiments, as may be combined with the preceding paragraphs, the one or more renewable feedstocks comprise at least about 75 wt. % triglycerides.

In one or more additional illustrative embodiments, as may be combined with the preceding paragraphs, the feed comprises from about 0.1 to about 50 wt. % of the one or more renewable feedstocks, based on the total weight of the feed.

In one or more additional illustrative embodiments, as may be combined with the preceding paragraphs, the feed comprises from greater than or equal to about 50 wt. % of the one or more renewable feedstocks, based on the total weight of the feed.

In one or more additional illustrative embodiments, as may be combined with the preceding paragraphs, the feed comprises 100 wt. % of the one or more renewable feedstocks.

In one or more additional illustrative embodiments, as may be combined with the preceding paragraphs, the feed further comprises one or more circular feedstocks.

In one or more additional illustrative embodiments, as may be combined with the preceding paragraphs, the circular feedstock is present in the feed in an amount of from about 0.1 wt. % to about 50 wt. %, based on the total weight of the feed.

In one or more additional illustrative embodiments, as may be combined with the preceding paragraphs, the feed further comprises one or more of a waste plastic feedstock, a pyrolysis-derived product of a waste plastic feedstock and combinations thereof.

In one or more additional illustrative embodiments, as may be combined with the preceding paragraphs, the feed comprises the waste plastic feedstock, and the waste plastic feedstock is present in the feed in an amount of from about 0.1 wt. % to about 20 wt. %, based on the total weight of the feed.

In one or more additional illustrative embodiments, as may be combined with the preceding paragraphs, the feed comprises the pyrolysis-derived product of a waste plastic feedstock, and the pyrolysis-derived product of a waste plastic feedstock is present in the feed in an amount of from about 0.1 to about 20 wt. % of the pyrolysis-derived product of the waste plastic feedstock, based on the total weight of the feed.

In one or more additional illustrative embodiments, as may be combined with the preceding paragraphs, the feed comprises from about 0.1 to about 10 wt. % of the waste plastic feedstock, based on the total weight of the feed, and from about 0.1 to about 20 wt. % of the pyrolysis-derived product of the waste plastic feedstock, based on the total weight of the feed.

In one or more additional illustrative embodiments, as may be combined with the preceding paragraphs, the heavy cycle oil comprises about 75 to about 99 wt. % of aromatics.

In one or more additional illustrative embodiments, as may be combined with the preceding paragraphs, the heavy cycle oil further comprises about 0.1 to about 0.5 wt. % sulfur and about 0.1 to about 0.5 wt. % nitrogen.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present compositions and are disclosed herein just as if each and every such sub-combination was individually and explicitly disclosed herein.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A method for making needle coke, comprising:
(a) processing a feed comprising one or more renewable feedstocks in the presence of a cracking catalyst under fluidized catalytic cracking conditions to obtain a heavy cycle oil;
(b) delayed coking the heavy cycle oil under coking conditions to obtain an intermediate coke product; and
(c) calcining the intermediate coke product under calcinating conditions to obtain needle coke.

2. The method according to claim 1, wherein the one or more renewable feedstocks comprise one or more of a plant, animal and microorganism type renewable feedstock.

3. The method according to claim 1, wherein the one or more renewable feedstocks comprise a material selected from the group consisting of monoglycerides, diglycerides, triglycerides, fatty acids and mixtures thereof.

4. The method according to claim 1, wherein the feed comprises from about 0.1 to about 50 wt. % of the one or more renewable feedstocks, based on the total weight of the feed.

5. The method according to claim 1, wherein the feed comprises from greater than or equal to about 50 wt. % of the one or more renewable feedstocks, based on the total weight of the feed.

6. The method according to claim 1, wherein the feed comprises 100 wt. % of the one or more renewable feedstocks.

7. The method according to claim 1, wherein the feed further comprises one or more circular feedstocks.

8. The method according to claim 1, wherein the feed further comprises one or more of a waste plastic feedstock, a pyrolysis-derived product of a waste plastic feedstock and combinations thereof.

9. The method according to claim 8, wherein the feed comprises from about 0.1 to about 10 wt. % of the waste plastic feedstock, based on the total weight of the feed, and from about 0.1 to about 20 wt. % of the pyrolysis-derived product of the waste plastic feedstock, based on the total weight of the feed.

10. The method according to claim 1, wherein the cracking catalyst comprises one of an equilibrium catalyst or a ZSM-5 catalyst.

11. The method according to claim 1, wherein the fluidized catalytic cracking conditions comprise a temperature of 425° C. to about 525° C., a catalyst regeneration temperature of about 600° C. to about 800° C.; a hydrocarbon partial pressure of about 100 to about 400 kPa, a catalyst-to-oil ratio from about 2:1 to about 20:1; and a catalyst contact time of about 1 to about 10 seconds.

12. The method according to claim 1, wherein the heavy cycle oil comprises about 75 to about 99 wt. % of aromatics.

13. The method according to claim 1, wherein the coking conditions comprise a temperature ranging from about 450 to about 520° C. for a time period ranging from about 12 to about 24 hours, and wherein the calcinating conditions comprise a temperature ranging from about 1250 to about 1400° C. for a time period ranging from about 30 to about 60 minutes.

14. The method according to claim 1, wherein delayed coking the heavy cycle oil comprises delayed coking the heavy cycle oil in the presence of an aromatic polymer material under coking conditions to obtain the intermediate coke product.

15. The method according to claim 14, wherein delayed coking the heavy cycle oil in the presence of the aromatic polymer material comprises cofeeding the heavy cycle oil and the aromatic polymer material into a delayed coker unit and delayed coking the co-fed heavy cycle oil and aromatic polymer material.

16. The method according to claim 14, wherein delayed coking the heavy cycle oil in the presence of the aromatic polymer material comprises delayed coking a solution of the heavy cycle oil and the aromatic polymer material in a delayed coker unit.

17. The method according to claim 16, wherein the solution comprises from about 0.1 to about 10 wt. % of the aromatic polymer material, based on the total weight of the solution.

18. The method according to claim 14, wherein the aromatic polymer material is polystyrene.

19. A method for making renewable needle coke, comprising:
(a) delayed coking a heavy cycle oil derived from one or more renewable sources and optionally one or more circular feedstocks under coking conditions to obtain an intermediate coke product; and
(b) calcining the intermediate coke product to obtain renewable needle coke.

20. The method according to claim 19, wherein delayed coking the heavy cycle oil comprises delayed coking the heavy cycle oil in the presence of an aromatic polymer material under coking conditions to obtain the intermediate coke product.
